(19) United States
(12) Patent Application Publication
(10) Pub. No.: US 2015/0012354 A1
(43) Pub. Date: Jan. 8, 2015

(54) Method and System for Placing and Presenting Advertisements

(71) Applicant: Adadapted, Inc., Ann Arbor, MI (US)

(72) Inventor: Michael Pedersen, Ann Arbor, MI (US)

(21) Appl. No.: 14/320,902

(22) Filed: Jul. 1, 2014

Related U.S. Application Data
(60) Provisional application No. 61/842,189, filed on Jul. 2, 2013.

(51) Int. Cl. G06Q 30/02

(52) U.S. Cl. CPC G06Q 30/0251
USPC 705/14.49

(57) ABSTRACT

A method includes receiving advertisement information and at least one advertisement asset; receiving placement information describing each placement from a plurality of placements; selecting a selected placement from the plurality of placements using the advertisement information and the placement information, and creating a placement specific advertisement using the advertisement asset, the advertisement information, and the placement information.

### CROSS-REFERENCE TO RELATED APPLICATIONS

This application claims the benefit of U.S. Provisional Patent Application Ser. No. 61/842,189, filed on Jul. 2, 2013.

### BACKGROUND

In the field of advertisements that are presented on computing devices, a common type of advertising is known as display advertising. Electronic or online display advertisements are very similar to traditional display advertisements from printed media. Both online and traditional display advertisements typically include a distinct block including one or more images and/or text. The content of a display advertisement is traditionally within control of the advertiser (i.e. the party purchasing the advertisement), who exercises final authority over the manner look of the advertisement and the context in which the advertisement, often by approving a proof prior to publication of the advertisement. Motivations for placing traditional display advertisements vary, but one common desired outcome is to motivate a consumer to purchase a good or service, or to seek out further information regarding the good or service.

Online display advertisements take many forms. One form of online display advertising is known as a banner ad. A banner ad is typically an image or an image in combination with text that is displayed adjacent to content that is presented on a computing device, where the content can be presented in the context of a document or in the context of an application. One example of a document in which advertising can be presented is a web page that is executed by a browser application. Examples of applications in which advertising can be presented include applications that are natively-executed by a computing device, and applications that are interpreted by another application, such as a “web application” in the form of executable code that is interpreted by a web browser.

Online display advertisements are typically associated by an action that can be performed by the user. In a common example, all or part of a display advertisement is a clickable user interface element (e.g. a hyperlink) that, when activated by the user, causes additional information regarding the subject of the advertisement to be displayed. In many known online advertising systems, instances of user interaction are tracked, and metrics can be generated. One example of such a metric is referred to as a “click-through rate,” and is presented in the form of a ratio or percentage that represents that number of times that the display advertisement is “clicked” relative to the number of times that it is displayed. Click through rates are typically very low, and for example, could be on the order of one click per one thousand impressions.

By their nature, display advertisements are separate from content. Because content is what users of an application or document are most interested in, users tend to focus on content instead of focusing on display advertising.

Another type of online advertising is referred to as native advertising. While there is no clear definition of what native advertising is, the intention behind native advertising is that it be displayed in-line with content. Although visual or written cues typically accompany native advertising to make its status as advertising clear, effective native advertisements are typically similar enough to content items that a user will read the native advertisements along with the content items. Thus, a native advertisement is tailored to a specific advertising channel, both in format and creative content, and would appear out of place in a different advertising channel. One common example of native advertising appears in the context of internet search engines, where sponsored search results can be displayed in-line with non-sponsored search result, but are typically identified as advertising by visual cues such as a colored background or text stating that the item is an advertisement.

Because of the need to tailor native advertisements to a specific channel, native advertisements have, in the past, been most effectively employed in very high volume channels that can deliver a very large number (e.g. millions) of advertising impressions to advertisers. Native advertising has not been effectively deployed in the context of channels that deliver smaller numbers of advertising impressions. As an example, consider an advertiser that wishes to purchase one million impressions of a native advertisement. That advertiser might be faced with the option of purchasing all of those impressions via a single channel, such as a search engine, or purchasing the same number of total impressions delivered by ten different smaller channels, each of which can deliver one-hundred thousand impressions. In this example, the smaller channels could be mobile applications that are executed by computationally-enabled mobile telephones (i.e. “Smart Phones). Although advertising might be more effective via the smaller channels, in terms of cost per impression or relevance of the individuals who use the channel, the advertiser is faced with the task of creating ten different native advertisements, each tailored for the channel in which it will appear.

### SUMMARY

The disclosure relates to methods for placing and presenting advertisements.

One aspect of the disclosed embodiments is a method that includes receiving, at one or more server computers from an advertiser system, advertisement information and at least one advertisement asset and receiving, at the one or more server computers from a plurality of publisher systems, placement information describing each placement from a plurality of placements. The method also includes selecting, by the one or more server computers, a selected placement from the plurality of placements using the advertisement information and the placement information. The method also includes creating, by the one or more sever computers, a placement specific advertisement using the advertisement asset, the advertisement information, and the placement information.

Another aspect of the disclosed embodiments is a method that includes receiving, at one or more server computers from an advertiser system, advertisement information and at least one advertisement asset and receiving, at the one or more server computers from a plurality of publisher systems, placement information describing each placement from a plurality of placements and placement assets corresponding to each placement from the plurality of placements. The method also includes selecting, by the one or more server computers, a plurality of selected placements from the plurality of placements using the advertisement information and the placement information. The advertisement information includes formatting criteria, the placement information for each placement includes formatting requirements, and the plurality of selected placements are selected by comparing the formatting criteria to the formatting requirements to determine whether the formatting criteria are compatible with the formatting requirements for each selected placement. The method also includes, for each selected placement, creating, by the one or more sever computers, a respective placement specific advertisement using the advertisement asset, the advertisement information, the placement information for the respective selected placement, and the placement asset for the respective selected placement, and associating the respective placement specific advertisement with the respective selected placement.

### BRIEF DESCRIPTION OF THE DRAWINGS

The description herein makes reference to the accompanying drawings wherein like reference numerals refer to like parts throughout the several views, and wherein:

FIG. 1 is a block diagram showing an example of a network environment that includes an advertising placement system;

FIG. 2 is a block diagram showing an example of a hardware configuration for a conventional computer;

FIG. 3A is an illustration showing a user interface for a first example application that includes one or more ad blocks;

FIG. 3B is an illustration showing a user interface for a second example application that includes one or more ad blocks;

FIG. 4 is a block diagram showing a placement matching operation;

FIG. 5 is a block diagram showing a placement specific advertisement building operation;

FIG. 6 is an illustration showing a group of advertisement assets;

FIGS. 7A-7D are examples of advertisement placements in applications based on the advertisement assets of FIG. 6;

FIG. 8 is a flow chart showing a first example of a method for placing and presenting advertisements;

FIG. 9 is a block diagram showing an alternative placement specific advertisement building operation; and

FIG. 10 is a flow chart showing a first example of a method for placing and presenting advertisements.

### DETAILED DESCRIPTION

The disclosure herein relates to methods and systems for placing and presenting advertising. The methods described herein can be utilized to automatically generate a native advertisement that is tailored to a specific presentation context based on information relating to the advertisement and information related to the presentation context. As a result, the methods and systems herein allow an advertiser to place native advertisements in each of a plurality of different presentation contexts without manually tailoring each advertisement for the presentation context in which it will appear. Furthermore, the presentation contexts in which advertisements can be presented using the systems and methods described herein can include presentations contexts in numerous difference applications that are created and / or published by different publishers. As used here, an application developer is an example of a publisher. In some cases, this can allow an application developer to offer native advertising opportunities in relatively low volume applications, where doing so via conventional systems would not be feasible due to the need to custom-tailor advertisements for specific presentation contexts in conventional systems.

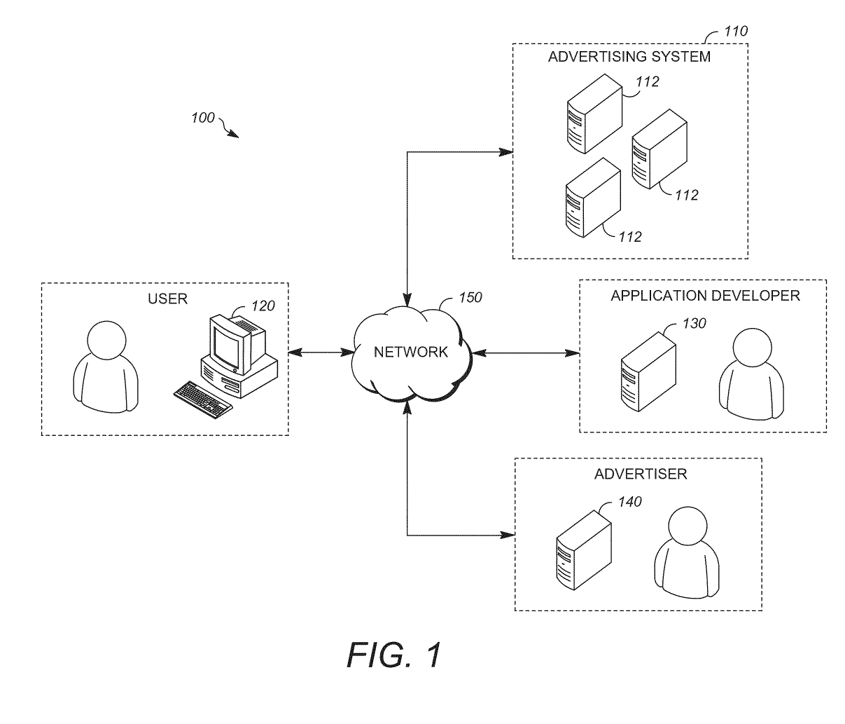

FIG. 1 is a block diagram that shows an example of an environment 100 that includes an advertising placement system 110. The environment 100 can also include one or more user devices 120 that are associated with users, one or more developer systems 130 (which may also be referred to as publisher systems) that are associated with application developers (which are examples of publishers), and one or more advertiser systems 140 that are associated with advertisers. Although the illustrated example shows only a single user, a single application developer, and a single advertiser, it should be noted that the environment 100 is intended to scale to accommodate any number of users, application developers, and advertisers. As an example, the methods and systems described herein can be applied to negotiate placement and presentation of advertisements on behalf of a large number of advertisers and application developers, such that each advertiser can place its advertisements within numerous applications from different application developers, and each application developer can present within its application numerous advertisements from different advertisers, with the advertising placement system 110 acting as a platform that facilitates these transactions without requiring direct communication between the advertisers and the application developers.

The advertising placement system 110 can be implemented using one or more server computers 112. Any configuration of the server computers 112 can be utilized. For example, the operations described herein could be performed by the server computers 112 in the form of multiple groups of server computers that are at different geographic locations and may or may not communicate with one another, such as by way of the network 150.

As will be explained herein, the advertising placement system 110 is configured to generate advertising content and server the advertising content to the user devices 120. The advertising content is generated at the advertising placement system 110 on behalf of and using information provided by the advertisers. The advertising content can be configured for display at the user devices 120 in the context of an application that is used at the at the user devices 120 and is developed, published by, or otherwise attributable to the application developer. Use of the application at the user devices 120 can include any or all of outputting information for display at the user devices 120, receiving user input via an input device at the user devices 120, and executing computer program instructions at the user devices 120. In some implementations, however, the application can be utilized at the user devices 120 without executing program instructions at the user devices 120, by executing program instructions for the application at a different computing device, such as a server computer.

The context in which the advertising content is presented is sometimes referred to herein as a presentation context. As examples, the presentation context can be an application or a document. Other types of presentation contexts are possible. The location within the application or document where the advertising content is presented is referred to herein as an advertising block. As an example, an advertising block can be an element or location within an application.

The user devices 120 are mobile computing devices such as, for example, a tablet computer or a smart-phone (a computationally-enabled mobile telephone). The developer system 130 and the advertiser system 140 can be any manner of computer or computing device, such as a desktop computer, a laptop computer, a tablet computer, or a smart-phone. In some cases, multiple computers or computing devices can be associated with a single user, application developer, and/or advertiser.

In some implementations, some or all of the user devices 120 can include a location subsystem that is operable to output information identifying a current physical location of the respective one of the user devices 120. As one example, the location subsystem can include a Global Positioning System receiver. Other technologies that can be utilized by the location subsystem include cellular or wireless network-based positioning, check-in systems, and user-input location information.

The network 150 can be one or more communications networks of any suitable type in any combination, including wireless networks, wired networks, local area networks, wide area networks, cellular data networks, and the internet. The advertising placement system 110, the user devices 120, the developer systems 130 and the advertiser systems 140 can all communication with each other via the network 150. In the implementations described herein, the user devices 120, the developer systems 130 and the advertiser systems 140 all communicate with the advertising placement system 110. It should be understood, however, that the systems and methods described herein could be implemented in manners that contemplate direct communication between any or all of the user devices 120, the developer systems 130 and the advertiser systems 140 via the network 150.

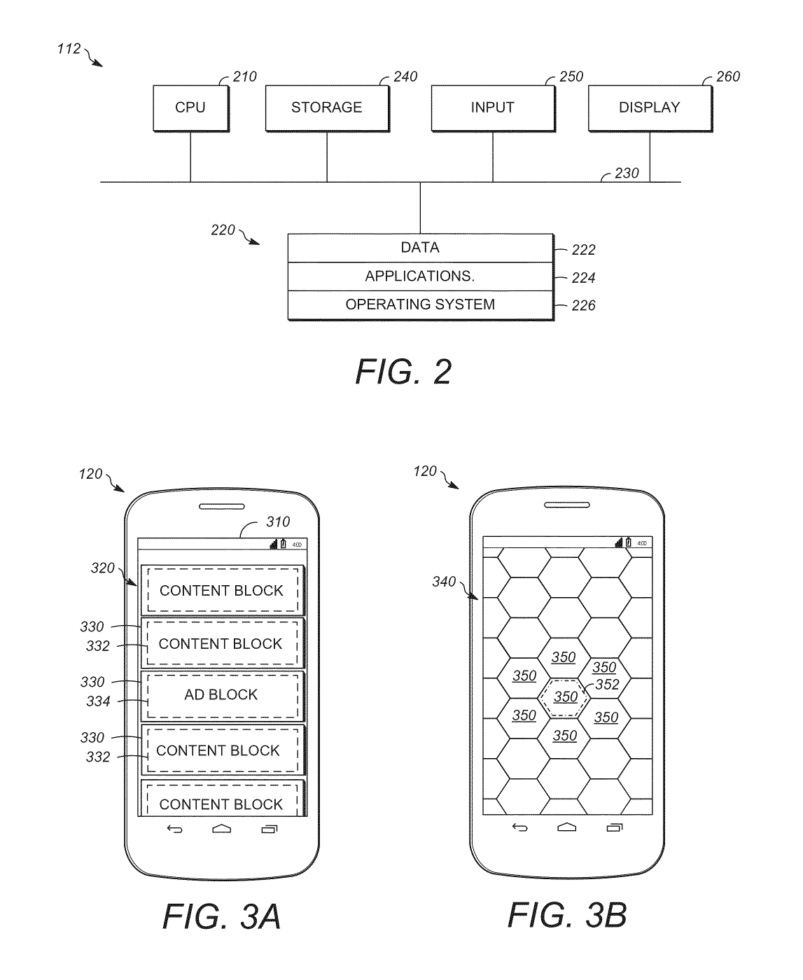

FIG. 2 is a block diagram of an example of a hardware configuration for a conventional computer, such as the server computers 112 of the advertising placement system 110. The same hardware configuration or a similar hardware configuration can be utilized to implement any or all of the user devices 120, the developer system 130, and the advertiser system 140.

The server computers 112 can each include a CPU 210. The CPU 210 can include one or more conventional central processing units. Alternatively, the CPU 210 can be any other type of device, or multiple devices, capable of manipulating or processing information now-existing or hereafter developed. Although the disclosed examples can be practiced with a single processor as shown, e.g. CPU 210, advantages in speed and efficiency can be achieved using more than one processor.

The server computers can each include a memory 220, such as a random access memory device (RAM). Any other suitable type of storage device can be used as the memory 220. The memory 220 can include code and data 222 that can be accessed by the CPU 210 using a bus 230. The memory 220 can further include one or more application programs 224 and an operating system 226. The application programs 224 can include software components in the form of computer executable program instructions that cause the CPU 210 to perform the operations and methods described herein.

A storage device 240 can be optionally provided in the form of any suitable computer readable medium, such as a hard disc drive, a memory device, a flash drive or an optical drive. One or more input devices 250, such as a keyboard, a mouse, or a gesture sensitive input device, receive user inputs and can output signals or data indicative of the user inputs to the CPU 210. One or more output devices can be provided, such as a display device 260. The display device 260, such as liquid crystal display (LCD) or a cathode-ray tube (CRT), allows output to be presented to a user, for example, in response to receiving a video signal.

Although FIG. 2 depicts the CPU 210 and the memory 220 as being integrated into a single unit, other configurations can be utilized. The operations of the CPU 210 can be distributed across multiple machines (each machine having one or more of processors) which can be coupled directly or across a local area or other network. The memory 220 can be distributed across multiple machine or device such as network-based memory or memory in multiple machines performing operations that may be described herein as being performed using a single computer or computing device. Although a single bus is depicted, multiple buses can be utilized. Further, the storage device 240 can be a component of each of the server computers 112 or can be a shared device that is accessed via a network. The one or more server computers 112 can thus be implemented in a wide variety of configurations.

FIG. 3A is an illustration showing one of the user devices 120 having a display screen 310 where a user interface 320 for a first example application is output for display at the display screen 310. Although the description herein is not limited in its applicability to a particular type of layout, the user interface 320 in the illustrated example uses a well-known table view layout. Other layouts can be utilized, such as a grid view layout. Also, while the user interface 320 can be utilized in the context of any type of application to deliver any type of information, examples of applications that can be implemented with the user interface 320 include an activity stream, news feed, or article list type application.

The user interface 320 includes a plurality of user interface elements 330. In some implementations, the user interface elements 330 are static user interface elements that provide no interactive functions. In other implementations, the user interface elements 330 are active user interface elements that provide one or more interactive functions. An interactive function is any manner of operation that is triggered by user interaction with the interface element, one common example being a navigation link (e.g. a hyperlink) that is activated in response to a user input (e.g. clicking or tapping the interface element). In other implementations, the user interface elements 330 can include both static user interface elements and active user interface elements. In some implementations, the user interface elements 330 can be GUI controls or GUI widgets.

One or more of the user interface elements 330 can have a content block 332 disposed within it, thus acting as a container or frame for the content block 332. In some implementations, including in the illustrated example, the user interface 320 includes multiple content blocks 332. The content blocks 332 can have data set in them, for example, to provide content or other information to the user. The content blocks 332 can include images, text, a combination of images and text, and/or other features. As an example, in an activity stream type application, each of the content blocks 332 can include information describing a specific activity such as text and/or a picture. Each of these content blocks 332 can be interactive, such as by causing additional information regarding the activity to be displayed when the interactive portion of the content block 332 is activated.

Portions of the user interface 320 including the user interface elements 330 and/or the content blocks 332 can include one or more characteristics that are specific to the application that outputs them for display, here, the first example application. These characteristics can include the shape of the user interface elements 330 and/or the content blocks 332, the size of the user interface elements 330 and/or the content blocks 332, standard images (raster or vector) incorporated in the user interface elements 330 and/or the content blocks 332 where standard images are defined as being selected from a library of one or more images that are associated with the application, color schemes for the user interface elements 330 and/or the content blocks 332, fonts used within the user interface elements 330 and/or the content blocks 332, and minimum and/or maximum lengths for text elements contained within the user interface elements 330 and/or the content blocks 332. Another characteristic of the interface elements and/or the content blocks 332 can be incorporation of a non-standard image, i.e. an image that is not associated with the application. For instance, in some applications, the content blocks 332 can include information describing documents that are external to the application. As an example, an application could include a list view that aggregates links to news articles from multiple third-party websites, where each content block 332 corresponds to a specific news article. In this example, each of the content blocks could include a non-standard image that is associated with the news article.

The user interface 320 also includes one or more advertising blocks 334. Each advertising block 334 is displayed within one of the user interface elements 330, which acts as a container or frame for the advertising block 334. The user interface elements 300 that contain the advertising blocks 334 can be displayed as members of a group of user interface elements 330, in-line with the other user interface elements 330 and adjacent to the user interface elements 330 that contain the content blocks 332. By way of example, in the user interface 320 of the first example application the user interface element 330 that contains the advertising block 334 is positioned between a pair of the user interface elements 330 that contain the content blocks 332, with one positioned above and another positioned below. The advertising blocks 334 can be static advertising blocks or active advertising blocks, where the content of the advertisement specifies an action or function to be performed in response to a user input that interacts with the user interface element 330 that contains the advertising block 334 or in response to a user input that interacts with a portion of the advertisement that is contained within the advertising block.

The advertising placement system 110 generates advertisements for placement within the advertising blocks 334. These advertisements are tailored to the application in which they appear. In addition, where a single application includes multiple types of user interface elements in which advertisements can be placed, the advertisements are tailored to a specific one of the types of user interface elements. As will be explained in detail herein, advertisements can be generated at the advertising placement system 110 for presentation in one of the advertising blocks 334. In order to tailor the advertisements for the application in which they are presented, the advertising placement system 110 can select and generate advertisements for the application by incorporating one or more of the characteristics that are specific to the application, as discussed previously. As an example, the advertising placement system 110 can generate an advertisement for placement in the advertising block 334 such that, when the advertisement is presented in the advertising block 334, the advertising block 334 includes some or all of the characteristics of the content blocks 332. As will also be explained further herein, this can be done for multiple advertisements that are presented in multiple presentation contexts in different applications based on a non-application specific set of advertisement criteria that is provided to the advertising placement system 110 by the advertiser.

FIG. 3B is an illustration where a user interface 340 for a second example application is output for display at the display screen 310 of one of the user devices 120. Although the description herein is not limited in its applicability to a particular type of application, the user interface 340 can be a game interface, where a plurality of user interface elements 350 can be, as examples portions of a field of play, scenery items, game pieces, or characters. In the same manner described with respect to the user interface 320, advertising blocks 352 can be contained within the user interface elements 350. However, in the user interface 340, the user interface elements 350 do not contain content blocks. In this example, the advertisements placed within the advertising blocks 352 are generated by the advertising placement system 110 such that they share some or all of the characteristics of the user interface elements 350.

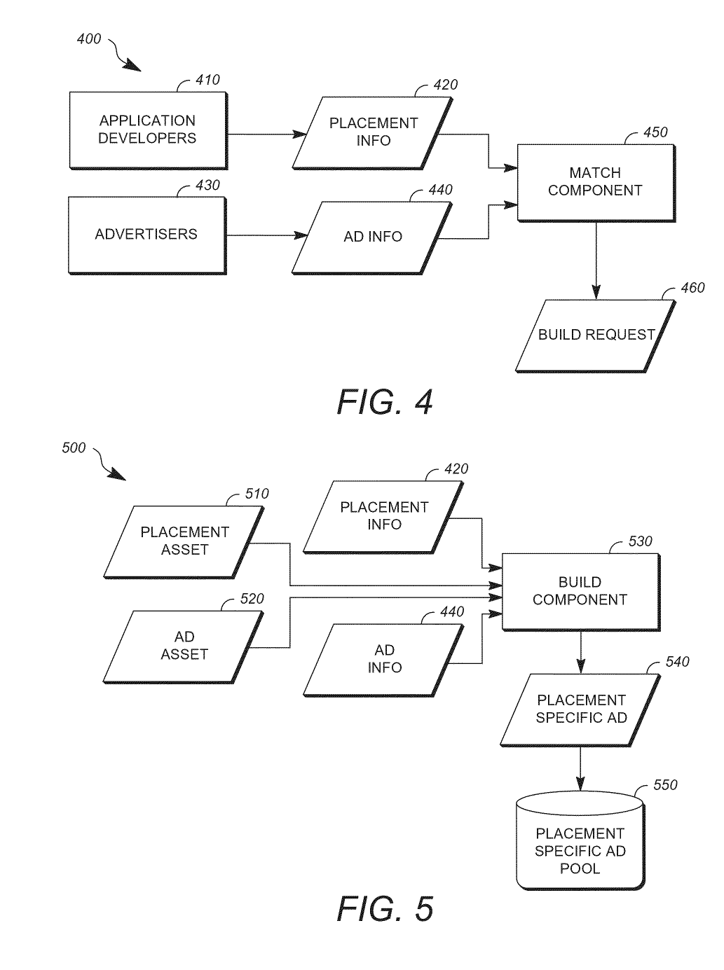

FIG. 4 is a block diagram showing a placement matching operation 400. In the placement matching operation 400, application developers 410 transmit placement information 420 to the advertising placement system 110, and advertisers 430 submit advertisement information 440 to the advertising placement system 110. The placement information 420 and the advertisement information 440 are stored, such as in a database, and are made accessible to a match component 450 of the advertising placement system 110. As an example, the match component 450 can be or include computer program instructions that are executed by the server computers 112 of the advertising placement system 110.

The placement information 420 includes information regarding the presentation context offered by a specific application developer as well as information regarding a specific advertising block in the presentation context. As examples, the information regarding the presentation context can include category information (utility application, productivity application, social media application, game application, blog, etc.), genre information, sub-genre information, user demographic information, and other types of information. The advertisement information 440 includes placement criteria that can be compared to the information regarding the presentation criteria. The placement information 420 also includes placement information describing one or more characteristics for a specified advertising block that will be utilized to generate a placement specific advertisement for the advertising block, including size, shape, color, fonts, layout, images, and other criteria as previously described. The advertisement information 440 can further include constraint information, where the constraint information describes acceptable and non-acceptable characteristics or ranges of characteristics.

The match component 450 can match an advertisement to a placement in a two stage matching process. First the placement information 420 and the advertisement information 440 are used by the match component 450 to identify suitable presentation contexts for the advertisement based on the information regarding the presentation context and the placement criteria. This first stage of the matching process is intended to match an advertisement with the user of the application in which the advertisement is placed. This can be done using factors including demographic information (gender ratio, age ranges etc.), categories, keywords, interest points, location information and other types of information. The output of this stage can be a ranked list of potential presentation contexts, with some potential presentation contexts having been eliminated based on the placement criteria.

In the second stage of the two stage matching process, the match component 450 compares the placement information 420 for each presentation context to identify placements that are compatible with the constraints described by the constraint information for each advertisement. The second part of the matching process is intended to ensure that the advertisement, when placed in a selected presentation context, will appear to be a native part of the application, by ensuring that the advertisement is able to be formatted in a manner that is consistent with the formatting in the application. In this stage, formatting criteria for advertisements are compared to formatting requirements for placements. The matching component 450 can exclude advertisements from matching with respect to placements where the formatting requirements set forth in the placement information 420 are incompatible with formatting criteria set forth in the advertisement information 440. As one example, an advertisement that requires inclusion of a text component and an image component would not be matched with a placement that allows advertisements that are solely image based. For some or all of the compatible placements (for example, a selected number of the top-ranked compatible placements), a build request 460 is generated.

The build request 460 requests generation of a placement specific advertisement for a specific placement. The build request can include information regarding the placement (specified ad block in specified presentation context), and information regarding the advertisement. Furthermore, the build request can include the placement information 420 and the advertisement information 440.

FIG. 5 is a block diagram showing a placement specific advertisement building operation 500. The placement specific advertisement building operation 500 can be performed in response to the build request 460, and receive information from the application developers 410 and the advertisers 430 as part of the build request 460, such as the placement information 420 and the advertisement information 440. This information, along with one or more placement assets 510 and/or one or more advertisement assets 520 can be provided to a build component 530. Based on the inputs, and as will be described, the build component generates a placement specific advertisement 540 and stores the placement specific advertisement in a placement specific advertisement pool 550, which is a group of advertisements (which may include advertisements from multiple advertisers) that are tailored for a specific placement, such as a specific advertisement block or user interface element in a specific presentation context (e.g. application). The placement specific advertisement 540 can be provided in any of many suitable formats. As one example, the placement specific advertisement can be in the form of an image that is created as a composite image by the build component 530 based on the information provided to the build component 530, such as the placement information 420, the advertisement information 440, the placement assets 510, and the advertisement assets 520. In another example, the placement specific advertisement 540 can be a collection of assets and information and / or executable program instructions such as the placement assets 510, the advertisement assets 520, and information or executable program instructions that are operable to cause the placement specific advertisement to be displayed as intended in the placement context at the user device 120. In some implementations, these elements can be provided in a container file. In other implementations, they can be transmitted to the user device separately. In another example, the placement specific advertisement can consist of information or executable program instructions that are operable to cause the placement specific advertisement to be displayed as intended in the placement context at the user device 120 by including information that causes any necessary assets, such as the advertisement assets 520, to be downloaded by the user device 120 from one or more server computers including, but not limited to, the advertising placement system 110. The foregoing are examples, and other forms of the placement specific advertisement 540 are possible.

In addition to the one or more placement assets 510 and/or one or more advertisement assets 520, additional assets could also be incorporated in the placement specific advertisement 540. For example, one or more assets can be provided by the advertising placement system 110, such as text or images that indicate that the placement specific advertisement 540 is an advertisement, or text or images identifying the entity that operates the advertisement placement system 110.

The placement assets 510 are submitted to the advertising placement system 110 by the application developers, for example, by transmission of the placement assets 510 to the server computers 112 of the advertising placement system 110 from the developer system 130 via the network 150. The placement assets 510 can be any type of media asset that is incorporated in the placement specific advertisement 540 in order to tailor the placement specific advertisement to a particular placement location by incorporating characteristics of the surrounding user interface elements from the presentation context where the placement specific advertisement 540 will appear. As examples, the placement assets 510 can include images, scripts, templates, and/or style sheets. For instance, the placement assets 510 can include images that are specific to a portion of the presentation context for which the placement specific advertisement 540 is being generated.

The advertisement assets 520 are submitted to the advertising placement system 110 by the advertisers 430, for example, by transmission of the advertisement assets 520 from the advertiser system 140 to the advertising placement system 110 via the network. The advertisement assets 520 can be any type of media asset that will be incorporated in the placement specific advertisement 540 as part of the advertising message from the advertiser 430. As examples, the advertisement assets can include text and / or images. While implementations within the scope of this disclosure can include advertisement assets 520 of any type, it should be understood that certain types of advertisement assets 520 could be excluded from incorporation in a particular placement, such as during the placement matching operation 400 as previously described.

The build component 530 generates the placement specific advertisement 540 using any or all of the placement information 420, the advertisement information, the placement assets 510 and the advertisement assets 520. The build component 530 can perform operations that include resizing, reshaping, recoloring and merging assets. In one example, the placement information 420 can require a strictly image image-based advertisement as the placement specific advertisement 540. In this example, the placement assets 510 could include one or more of the standard images that were described with respect to the user interface 320 of FIG. 3A, and the advertisement assets can include one or more advertisement images that are resized, reshaped, and / or recolored, and then merged with the standard images to define the placement specific advertisement, which is then saved into the placement specific advertisement pool 550.

In some implementations, the requirements of the placement information 420 and the criteria of the advertisement information 440 can define an overlapping range of acceptable parameters that the build component 530 can utilize to generate the placement specific advertisement 540. In such a situation, the build component 530 can select a suitable parameter value for creation of the placement specific advertisement, by using a default rule, a calculation, or random selection. As an alternative, the build component 530 can generate multiple advertisements based on the same information and assets, and the advertising placement system 110 can subsequently track the performance of the multiple advertisements and subsequently eliminate one or more low-performing advertisements from the placement specific advertisement pool 550.

The placement specific advertisement pool 550 is utilized to provide advertisements to a specific placement in response to requests for advertisements. A presentation context, such as an application executed at one of the user devices 120, requests an advertisement. The request can be initiated by computer program instructions that correspond to the advertising block where the advertisement will be displayed, and the request can include information that identifies the advertising block. The request is transmitted from the user device 120 to advertising placement system 110. The advertising placement system 110 can select one of the placement specific advertisements 540 from the placement specific advertisement pool 550. This selection can be made by ranking the advertisements within the placement specific advertisement pool based on any suitable criteria. Information regarding the selected placement specific address is transmitted to the user device 120, and the information, when interpreted by the application at the user device 120, causes the placement specific advertisement 540 to be output for display at the user device 120 in the context of the application and within the advertising block. The information can further define actions that can be performed in response to user interaction (e.g. clicking) with the advertisement, such as opening a popup, navigating to a specified URL, causing the user device 120 to execute an external application, or causing the user device to download a specified application.

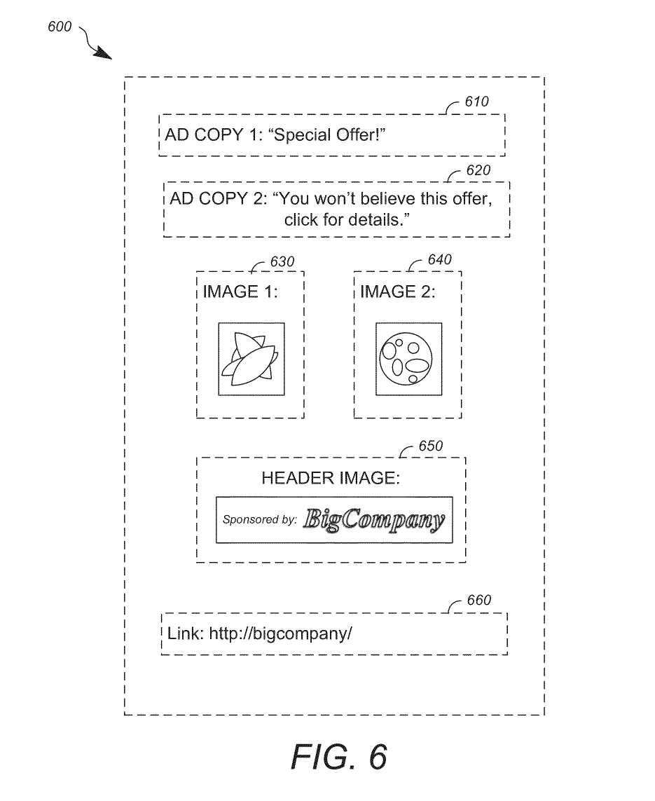

From the foregoing description, it should be understood that the advertising placement system 110 allows an advertiser to define a single advertisement that can be displayed in multiple presentation contexts, where the advertisement is tailored to meet the requirements of each presentation context. Thus, the advertisement can appear as a native advertisement without the need for manual modification of the advertisement for each separate presentation context. As an example, FIG. 6 shows a group of advertisement assets 600, which are examples of data elements that can be utilized to generate an advertisement. The advertisement assets 600 are examples, and it should be understood that assets of other types can be utilized to generated advertisements.

The advertisement assets 600 include a first ad copy element 610, a second ad copy element 620, a first image element 630, a second image element 640, a header image 650, and a hyperlink address 660. In this example, advertisement information associated with the advertisement assets 600 defines the first ad copy element 610 as optional, defines the second ad copy element 620 as required, defines each of the first image element 630 and the second image element 640 as optional, and defines the header image 650 as optional. The advertisement information of this example also specifies that one, but not both, of the first image element 630 or the second image element 640 may be displayed alongside the first ad copy element 610 and the second ad copy element 620. The advertisement information can further specify minimum and maximum font sizes for each of the first ad copy element and the second ad copy element, as well as specifying permissible cropping and resizing parameters for each of the first image element 630 and the second image element 640.

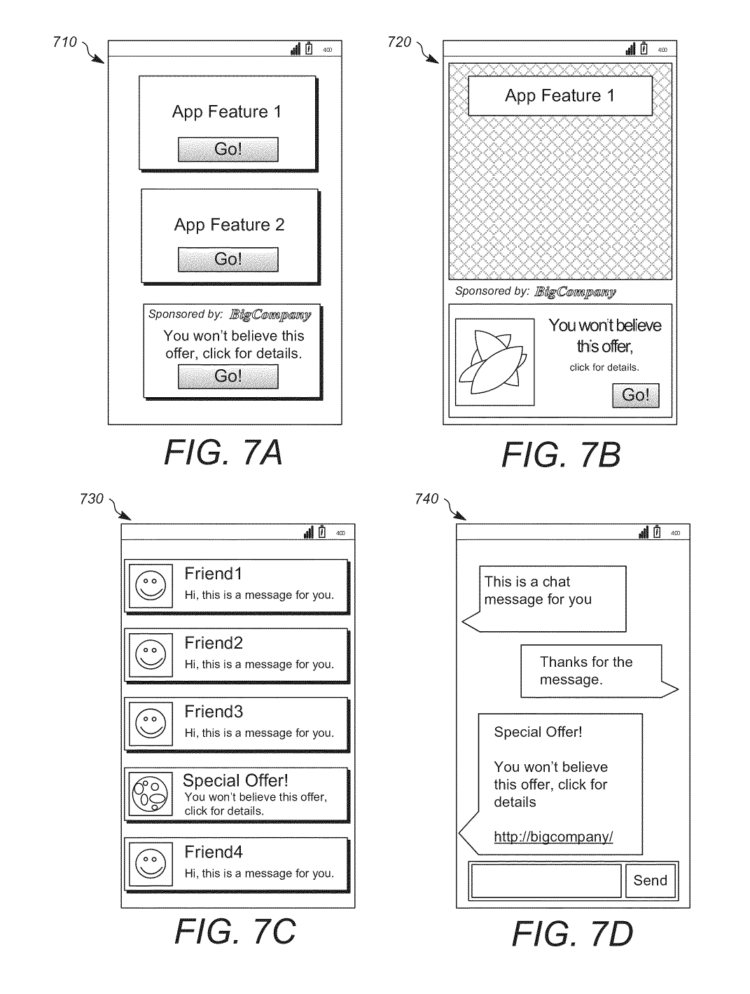

FIG. 7A shows a first example 710 of placement of an advertisement based on the advertisement assets 600 and the associated advertisement information. In the first example 710 a placement in a menu screen of an application was selected as being compatible with the advertisement assets 600, and the placement criteria allowed usage of the header image 650 and the second ad copy element 620, each of which were sized, formatted, and colored according to the placement requirements of the application, placed in a frame that is specific to the application, and associated with a button that is specific to the application and that, when clicked, allows navigation to the hyperlink address 660.

FIG. 7B shows a second example 720 of placement of an advertisement based on the advertisement assets 600 and the associated advertisement information. In the second example 720 a placement in an application feature screen of an application was selected as being compatible with the advertisement assets 600, and the placement criteria allowed usage of the header image 650, the first image element 630, and the second ad copy element 620, each of which were sized, formatted, and colored according to the placement requirements of the application, placed in a frame that is specific to the application, and associated with a button that is specific to the application and that, when clicked, allows navigation to the hyperlink address 660.

FIG. 7C shows a third example 730 of placement of an advertisement based on the advertisement assets 600 and the associated advertisement information. In the third example 730 a placement in an news feed type screen of an application was selected as being compatible with the advertisement assets 600, and the placement criteria allowed usage of the second image element 640, the first ad copy element 610, and the second ad copy element 620, each of which were sized, formatted, and colored according to the placement requirements of the application, placed in a frame that is specific to the application. When the frame is clicked, the application causes navigation to the hyperlink address 660.

FIG. 7D shows a fourth example 740 of placement of an advertisement based on the advertisement assets 600 and the associated advertisement information. In the third example 740 a placement in an chat message screen of an application was selected as being compatible with the advertisement assets 600, and the placement criteria allowed usage of the first ad copy element 610, and the second ad copy element 620, each of which were sized, formatted, and colored according to the placement requirements of the application, placed in a frame that is specific to the application. The advertisement also includes a text hyperlink that causes navigation to the hyperlink address 660 when clicked.

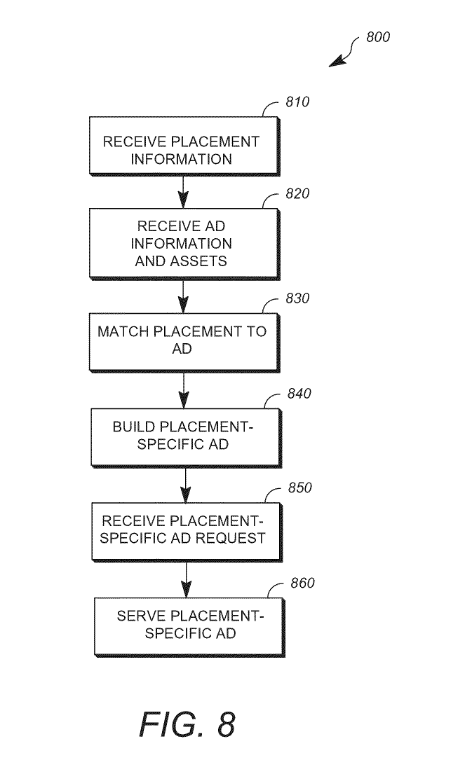

FIG. 8 is a flow chart showing an example of a process 800 for placing and presenting advertisements. The operations described in connection with the process 800 can be performed at one or more computers, such as at the one or more server computers 112 of the advertising placement system 110. When an operation is performed by one or more computers, it is completed when it is performed by one computer. The operations described in connection with the process 800 can be embodied as a storage device in the form of a non-transitory computer readable storage medium including program instructions executable by one or more processors that, when executed, cause the one or more processors to perform the operations. For example, the operations described in connection with the process 800 could be stored at the memory 220 of the one or more server computers 112 and be executable by the CPU 210 of the one or more server computers 112.

At operation 810, placement information is received regarding locations in presentation contexts at which advertisements can be presented. The placement information can be received, for example, at the advertising placement system 110 from the developer systems 130. At operation 820, advertisement information and advertisement assets are received. For example, the advertisement information and assets can be received at the advertising placement system 110 from the advertiser systems 140.

At operation 830 the advertising placement system 110 identifies a selected placement for an advertisement using the placement information and the advertisement information. Operation 830 can be performed in the manner described with respect to the placement matching operation 400. At operation 840, the placement information, the advertisement information, and the advertisement assets are used to generate one or more placement specific advertisements, which are then stored. Operation 840 can be performed in the manner described with respect to the placement specific advertisement building operation 500.

At operation 850, a request is received for an advertisement to be shown at an identified placement. The request for an advertisement to be shown at an identified placement can be received from one of the user devices 120 and can include information to facilitate selection of a placement specific advertisement, such as information identifying the location of the user or other information that can be utilized as a basis for selection of the advertisement. Features can be implemented to protect the privacy of the user, such as anonymizing the user's identity.

At operation 860, a placement specific advertisement is selected, retrieved, and transmitted in response to the request. For example, the request can be received from one of the user devices 120, the placement specific advertisement is then selected based in part on information received from the user, and is served to the user device 120 from which the request was received.

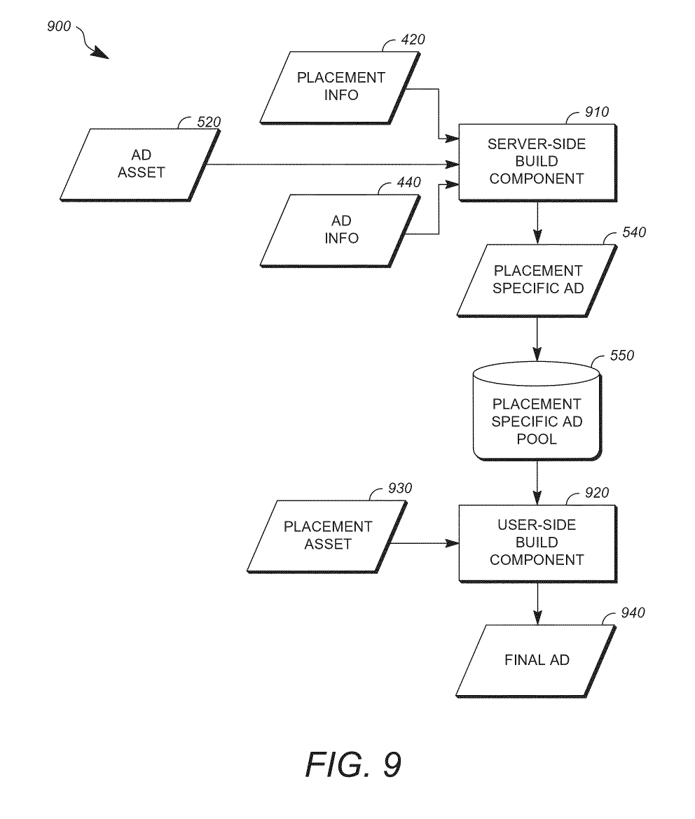

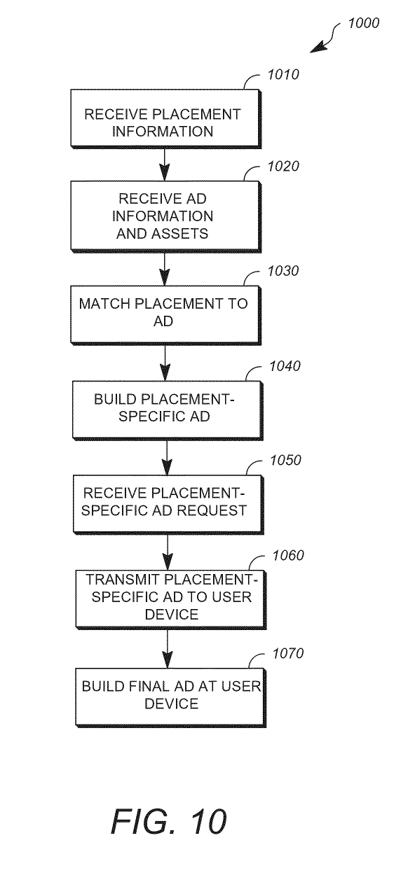

FIG. 9 is a block diagram showing an alternative placement specific advertisement building operation 900. The alternative placement specific advertisement building operation 900 is similar to the placement specific advertisement building operation 500, except as noted herein. In particular, the placement specific advertisement 540 is generated and placed in the placement specific advertisement pool 550 by a server side build component 910, which is similar to the build component 530. In some implementations, however, the server side build component 910 does not incorporate placement specific assets in the placement specific advertisement 540. Instead, when the placement specific advertisement 540 is transmitted to the user device 120, a user-side build component 920 combines the placement specific advertisement 540 with one or more placement specific assets 930 to generate a final advertisement 940, which can be output for display at the user device 120 in a desired presentation context.

The placement specific assets 930 can be stored at the user device 120. Alternatively, the placement specific assets 930 can be identified by information that is located at the user device 120 and retrieved from an external server computer as needed. In either case, the application developer retains control over the placement specific assets 930 without having to submit them to the advertising placement service, thereby allowing the application developer to fine tune the placement specific assets or change the placement specific assets entirely without submitting those assets to the advertising placement service. In addition, bandwidth usage from the advertising placement system to the user devices 120 can be saved, by reducing the data size of the assets that are transmitted when an advertisement is served.

The placement specific assets 930 or information identifying them can be part of the application that is executed at the user device 120 and in which the advertisement is placed. Similarly, the user-side build component 920 is located at the user device 120 and can be part of the application that is executed at the user device 120.

The alternative placement specific advertisement building operation 900 can be utilized in conjunction with an alternative process 1000 for placing and presenting advertisements. The operations described in connection with the alternative process 1000 can be performed at one or more computers, such as at the one or more server computers 112 of the advertising placement system 110. When an operation is performed by one or more computers, it is completed when it is performed by one computer. The operations described in connection with the alternative process 1000 can be embodied as a storage device in the form of a non-transitory computer readable storage medium including program instructions executable by one or more processors that, when executed, cause the one or more processors to perform the operations. For example, the operations described in connection with the alternative process 1000 could be stored at the memory 220 of the one or more server computers 112 and be executable by the CPU 210 of the one or more server computers 112.

At operation 1010, placement information is received regarding locations in presentation contexts at which advertisements can be presented. The placement information can be received, for example, at the advertising placement system 110 from the developer systems 130. At operation 1020, advertisement information and advertisement assets are received. For example, the advertisement information and assets can be received at the advertising placement system 110 from the advertiser systems 140.

At operation 1030 the advertising placement system 110 identifies a selected placement for an advertisement using the placement information and the advertisement information. Operation 1030 can be performed in the manner described with respect to the placement matching operation 400. At operation 1040, the placement information, the advertisement information, and the advertisement assets are used to generate one or more placement specific advertisements, which are then stored. Operation 1040 can be performed in the manner described with respect to the alternative placement specific advertisement building operation 900.

At operation 1050, a request is received for an advertisement to be shown at an identified placement. The request for an advertisement to be shown at an identified placement can be received from one of the user devices 120 and can include information to facilitate selection of a placement specific advertisement, such as information identifying the location of the user or other information that can be utilized as a basis for selection of the advertisement. Features can be implemented to protect the privacy of the user, such as anonymizing the user's identity.

At operation 1060, a placement specific advertisement is selected, retrieved, and transmitted in response to the request. For example, the request can be received from one of the user devices 120, and the placement specific advertisement is then selected based in part on information received from the user, and is served to the user device 120 from which the request was received.

At operation 1070 the placement specific ad is received, such as the user device 120, and is combined with a placement specific asset to generate a final advertisement. Operation 1070 can be performed as described in connection with the alternative placement specific advertisement building operation 900. The final advertisement is then output for display, for example, at a display device that is associated with the user device 120.

The foregoing examples describe placement specific advertisements being displayed in an ad block within a presentation context such as an application. In some implementations, a single presentation context can include multiple ad blocks. Each of these ad blocks can have its own placement information, such as formatting requirements. However, the ad blocks can be related such that placement specific ads for a single advertisement are built for all of the ad blocks. For related ad blocks, when an application executed by the user device 120 requests the placement specific advertisement for one of the ad blocks, the placement specific ads for all of the related ad blocks can be transmitted to the first user device by the advertising placement system 110. In such an example, the placement matching operation 400 is unchanged. In the placement specific advertisement building operation 500, the build component 530 can receive sets of assets and information for each of the placement specific advertisements that will be created in order to define related ad blocks in the presentation context. By defining related ad blocks, the advertiser can apply consistent branding throughout a presentation context.

When placement specific advertisements are related to one another, this information can be utilized by either the advertising placement system 110 or the presentation context itself to cause transmission of several related advertisements when one of them is requested. In a first example, the advertising placement system 110 receives a request from a presentation context for an advertisement to be displayed in an ad block, the advertising system can select a first advertisement, access information regarding the advertisement, and based on that information, identify one or more related advertisements that can appear elsewhere in the presentation context but have not yet been requested. The requested advertisement and the related advertisements can then be transmitted, such that the related advertisements are available to the presentation context when they are needed. In another example, the presentation context can determine that an advertisement is needed for a first ad block that is being output for display, identify one or more related ad blocks that are not currently being output for display, and request transmission of a first advertisement for the first ad block and one or more additional advertisements for the related ad blocks, prior to display of the related ad blocks. In both examples, by transmitting the related placement specific ads together, disruption of the user's experience is avoided.

As previously described, all or part of an advertisement can be a clickable user interface element (e.g. a hyperlink) that, when activated by the user, causes additional information regarding the subject of the advertisement to be displayed. In alternative implementations, content can be transmitted to the user device 120 that is associated with the advertisement, but does not necessarily relate to the subject matter of the advertisement (i.e. the good or service being advertised). In such an implementation, the application developer can define an area within the presentation context for display of this additional content, the advertiser can include the additional context as part of the advertisement assets, and an advertisement can be matched to a potential placement in part based on the ability of the placement to display the additional content.

One example is sponsored content. Sponsored content can be transmitted with a placement specific advertisement and be displayed with the placement specific advertisement and/or displayed in response to user operation of an interface element within the placement specific advertisement. For example, in a recipe organizer application, sponsored content could be recipes that are displayed in response to user operation of an interface element that is associated with the advertisement. The application developer would modify the application to include one or more pages that are configured to cause display of the sponsored content. In response to a user request for the sponsored content, one of these pages would be output for display by the presentation context, the presentation context would request the sponsored content from the advertising placement system 110, and the content would be displayed within the page. In these examples, the placement information could specify that the advertisement, in order to be a match, must include a certain number of content items.

In another implementation, the additional information regarding the subject of the advertisement that is displayed is response to a user input can be a pop-up display area that includes advertiser provided content that is formatted according to the formatting requirements of the presentation context, such as by incorporating visual characteristics of the presentation context such as header color, background, color, font, and size.

In any of the examples given herein, placement specific advertisements can be updated at the time they are displayed based on data transmitted to the advertising placement system 110 by the application in which the advertisement is displayed. As one example, in a search application, a placement specific advertisement can be updated based on the search results. As another example, in an e-commerce application, the contents of a user's e-commerce shopping cart or the purchase amount can be utilized to update the placement specific advertisement, such as by indicating savings associated with using a particular credit card with the savings amount being calculated based on the purchase amount.

In another implementation, an application can monitor user actions and transmit, to the advertising placement system, a request for new advertisements for a new placement, with the placement being specific to the user actions. In response to the request, one or more placement specific advertisements are matched to the placement, the ads are created in real-time, and transmitted to the application for display to the user.

As used herein, information, signals, or data are received by transmission or accessing the information, signals, or data in any form, such as receiving by transmission over a network, receiving by accessing from a storage device, or receiving by user operation of an input device.

The foregoing description describes only some exemplary implementations of the described techniques. Other implementations are available. For example, the particular naming of the components, capitalization of terms, the attributes, data structures, or any other programming or structural aspect is not mandatory or significant, and the mechanisms that implement the systems and methods described herein or their features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

The implementations of the computer devices (e.g., clients and servers) described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of each of the clients and each of the servers described herein do not necessarily have to be implemented in the same manner.

Operations that are described as being performed by a single processor, computer, or device can be distributed across a number of different processors, computers or devices. Similarly, operations that are described as being performed by different processors, computers, or devices can, in some cases, be performed by a single processor, computer or device.

Although features may be described above or claimed as acting in certain combinations, one or more features of a combination can in some cases be excised from the combination, and the combination may be directed to a sub-combination or variation of a sub-combination.

The systems described herein, such as client computers and server computers, can be implemented using general purpose computers/processors with a computer program that, when executed, carries out any of the respective methods, algorithms and/or instructions described herein. In addition or alternatively, for example, special purpose computers/processors can be utilized which can contain specialized hardware for carrying out any of the methods, algorithms, or instructions described herein.

Some portions of above description include disclosure presented in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality. It should be noted that the process steps and instructions of implementations of this disclosure could be embodied in software, firmware or hardware, and when embodied in software, could be downloaded to reside on and be operated from different platforms used by real time network operating systems.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

At least one implementation of this disclosure relates to an apparatus for performing the operations herein. This apparatus may be specially constructed for the required purposes, or it may comprise a general-purpose computer selectively activated or reconfigured by a computer program stored on a computer readable storage medium that can be accessed by the computer.

All or a portion of the embodiments of the disclosure can take the form of a computer program product accessible from, for example, a non-transitory computer-usable or computer-readable medium. The computer program, when executed, can carry out any of the respective techniques, algorithms and/or instructions described herein. A non-transitory computer-usable or computer-readable medium can be any device that can, for example, tangibly contain, store, communicate, or transport the program for use by or in connection with any processor. The non-transitory medium can be, for example, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for tangibly containing, storing, communicating, or transporting electronic instructions.

It is to be understood that the disclosure is not to be limited to the disclosed embodiments but, on the contrary, is intended to cover various modifications and equivalent arrangements included within the spirit and scope of the appended claims.

What is claimed is:

1. A method, comprising:
receiving, at one or more server computers from an advertiser system, advertisement information and at least one advertisement asset;
receiving, at the one or more server computers from a plurality of publisher systems, placement information describing each placement from a plurality of placements;
selecting, by the one or more server computers, a selected placement from the plurality of placements using the advertisement information and the placement information; and
creating, by the one or more sever computers, a placement specific advertisement using the advertisement asset, the advertisement information, and the placement information.

2. The method of claim 1, wherein the advertisement information includes formatting criteria and the placement information for each placement includes formatting requirements.

3. The method of claim 2, wherein selecting the selected placement is based at least in part on comparing the formatting criteria to the formatting requirements to determine whether the formatting criteria are compatible with the formatting requirements for the selected placement.

4. The method of claim 2, wherein creating the placement specific advertisement is performed using the formatting criteria and the formatting requirements such that the placement specific advertisement satisfies both the formatting criteria and the formatting requirements.

5. The method of claim 1, wherein the advertisement asset includes at least one of a text element or an image.

6. The method of claim 1, wherein the advertisement asset is an image and creating the placement specific advertisement includes at least one or resizing, reshaping, or recoloring the image.

7. The method of claim 1, further comprising:
receiving, from a first publisher system from the publisher systems, at least one placement asset, wherein creating the placement specific advertisement is performed using the placement asset such that the placement specific advertisement includes the advertisement asset and the placement asset.

8. The method of claim 7, wherein the placement asset includes at least one of an image, a script, a template, or a style sheet.

9. The method of claim 7, wherein the advertisement asset is an advertisement image, the placement asset is a placement image, and creating the placement specific advertisement includes merging the advertisement image and the placement image into a merged image.

10. The method of claim 1, wherein each placement from the plurality of placements is associated with a specific ad block in a specific application that is associated with a specific publisher.

11. The method of claim 10, wherein the placement information includes information defining characteristics of one or more interface elements from the specific application and creating the placement specific advertisement using the placement information causes the characteristics of the one or more interface elements to be incorporated in the placement specific advertisement.

12. The method of claim 1, further comprising:
associating the placement specific advertisement with a specific ad block of a specific application.

13. The method of claim 12, further comprising:
receiving a request from a user system, the request including information that identifies the specific ad block of the specific application; and
in response to the request from the user system, transmitting the placement specific advertisement from the one or more sever computers to the user system for display within the specific ad block of the specific application.

14. A method, comprising:
receiving, at one or more server computers from an advertiser system, advertisement information and at least one advertisement asset;
receiving, at the one or more server computers from a plurality of publisher systems, placement information describing each placement from a plurality of placements and placement assets corresponding to each placement from the plurality of placements;
selecting, by the one or more server computers, a plurality of selected placements from the plurality of placements using the advertisement information and the placement information, wherein the advertisement information includes formatting criteria, the placement information for each placement includes formatting requirements, and the plurality of selected placements are selected by comparing the formatting criteria to the formatting requirements to determine whether the formatting criteria are compatible with the formatting requirements for each selected placement; and
for each selected placement:
creating, by the one or more sever computers, a respective placement specific advertisement using the advertisement asset, the advertisement information, the placement information for the respective selected placement, and the placement asset for the respective selected placement, and
associating the respective placement specific advertisement with the respective selected placement.

15. The method of claim 14, wherein creating the respective placement specific advertisement is performed using the formatting criteria and the formatting requirements for the respective selected placement such that the respective placement specific advertisement satisfies both the formatting criteria and the formatting requirements for the respective selected placement.

16. The method of claim 14, wherein the advertisement asset includes at least one of a text element or an image.

17. The method of claim 14, wherein each of the placement assets includes at least one of an image, a script, a template, or a style sheet.

18. The method of claim 14, wherein each placement from the plurality of placements is associated with a specific ad block in a specific application that is associated with a specific publisher.

19. The method of claim 18, wherein the placement information for each placement includes information defining characteristics of one or more interface elements from the specific application and creating the placement specific advertisement using the placement information causes the characteristics of the one or more interface elements to be incorporated in the placement specific advertisement.

20. The method of claim 18, further comprising:
receiving a request from a user system, the request including information that identifies one of the specific ad blocks of one of the specific applications; and
in response to the request from the user system,
identifying an identified placement from the plurality of placements that corresponds to the specific ad block of the specific application, and
transmitting the respective placement specific advertisement that is associated with the identified placement from the one or more sever computers to the user system for display within the specific ad block of the specific application.
